(19) United States
(12) Patent Application Publication
(10) Pub. No.: US 2003/0095023 A1
(43) Pub. Date: May 22, 2003

(54) Transformer

(76) Inventor: Jens Frank Markwardt, Kwai Fong (HK)

Correspondence Address: JACKSON WALKER L.L.P., Suite 2100, 112 E. Pecan Street, San Antonio, TX, 78205, US

(21) Appl. No.: 10/058,853

(22) Filed: Jan. 28, 2002

(30) Foreign Application Priority Data
Nov. 19, 2001 (EP) 01309737.3

(51) Int. Cl. H01F 27/02

(52) U.S. Cl. 336/90

(57) ABSTRACT

A transformer includes first and second transformer windings formed on an iron core. The core and windings are disposed in an enclosure. There are first and second electrical pins in electrical connection with the first transformer winding. A second inner enclosure made of fire retardant material encases a portion of the electrical pins and the first transformer winding in connection with the electrical pins.

### FIELD OF THE INVENTION

The invention relates to transformers, and in particular to low voltage transformers used in battery charges for rechargeable consumer products.

### BACKGROUND OF THE INVENTION

Low voltages transformers for use in battery chargers for rechargeable consumer products are well known. The transformer comprises an iron core carrying first and second transformer windings. The transformer is housed within an enclosure. Projecting from the outer surface of the enclosure are electrical pins adapted to engage an electrical wall outlet. The pins are in electrical connection with the first winding for energising the transformer. The second winding is connected to a rectifier and output cord.

In order to comply with electrical safety standards the enclosure must be made from fire retardant material. The choice of material depends on the operating temperature and normal fault operating temperature of the transformer according to various international safety standards such as UL1950 or EN60950. Fire retardant material is more expensive then normal plastics material and this adds to the cost of the enclosure.

### SUMMARY OF THE INVENTION

It is an object of the present invention to provide a transformer and/or battery charger assembly that overcomes or ameliorates the above disadvantage or at least provides the public with a useful alternative.

According to a first aspect of the invention there is provided a transformer including:

first and second transformer windings,

an iron core carrying said first and second transformer windings,

an enclosure housing the iron core and first and second transformer windings,

first and second electrical connectors in electrical communication with the first transformer winding, and

a second enclosure encasing the electrical connectors and portion of the first transformer winding in electrical communication with the connectors.

The second enclosure is made of fire retardant material. Preferably the transformer includes an electrical pin assembly in removable communication with the first and second electrical connectors, said pin assembly disposed to project from the outer surface of the enclosure to facilitate connection of the transformer with an electrical wall outlet.

In one embodiment the transformer may included a winding bobbin that forms part of the second enclosure.

According to a second aspect of the invention there is provided a battery charger including:

first and second transformer windings,

an iron core carrying said first and second transformer windings,

an enclosure housing the iron core and first and second transformer windings,

an electrical pin assembly in electrical connection with the first transformer winding, and

a second enclosure made of fire retardant material encasing a portion of the electrical pin assembly and the first transformer winding in connection with the electrical pin assembly.

In one embodiment at least the first winding is formed on a bobbin that forms part of the second enclosure.

Further aspects of the invention will become apparent from the following description, which is given by way of example only.

### BRIEF DESCRIPTION OF THE DRAWINGS

Embodiments of the invention will now be described by way of example only and with reference to the accompanying drawings in which:

FIG. 1 illustrates a first perspective view of a battery charger utilising a transformer according to the invention,

FIG. 2 illustrates a second perspective view of the battery charger,

FIG. 3 illustrates an exploded view of the battery charger showing the transformer,

FIG. 4 illustrates a cross-section through the battery charger and transformer,

FIG. 5 illustrates an exploded view of a second embodiment of a battery charger showing a transformer according to the invention,

FIG. 6 illustrates a cross-section through the battery charger and transformer of FIG. 5,

FIG. 7 illustrates an exploded view of a third embodiment of a battery charger showing a transformer according to the invention, and

FIG. 8 illustrates a cross-section through the battery charger and transformer of FIG. 7.

### DESCRIPTION OF THE PREFERRED EMBODIMENTS

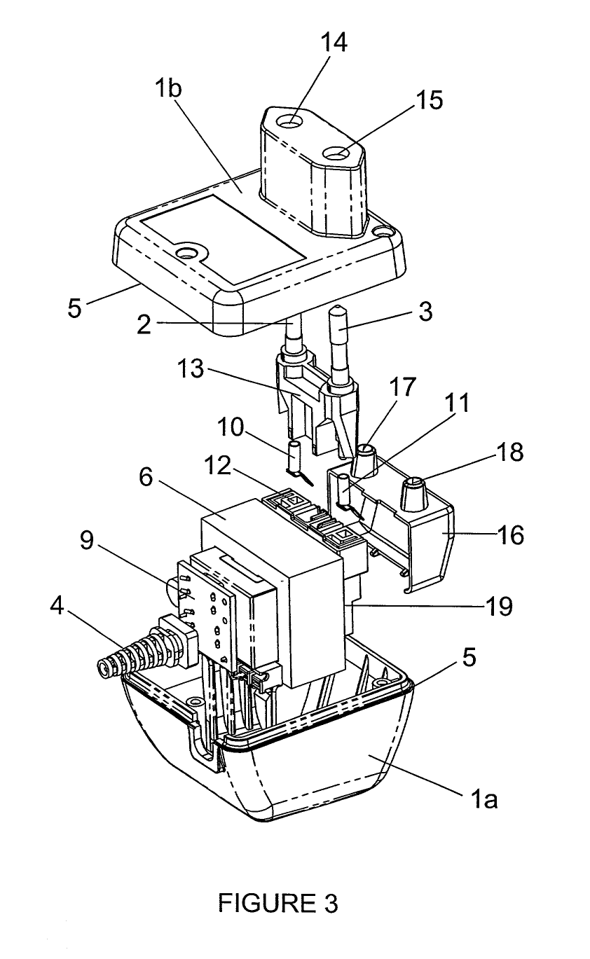

The invention will now be described with reference to the accompanying drawings in which FIGS. 3 and 4, 5 and 6, and 7 and 8 are three embodiments adapted for the European, United Kingdom, and United States markets respectively. The following description refers equally to each embodiment and like reference numerals refer to like features.

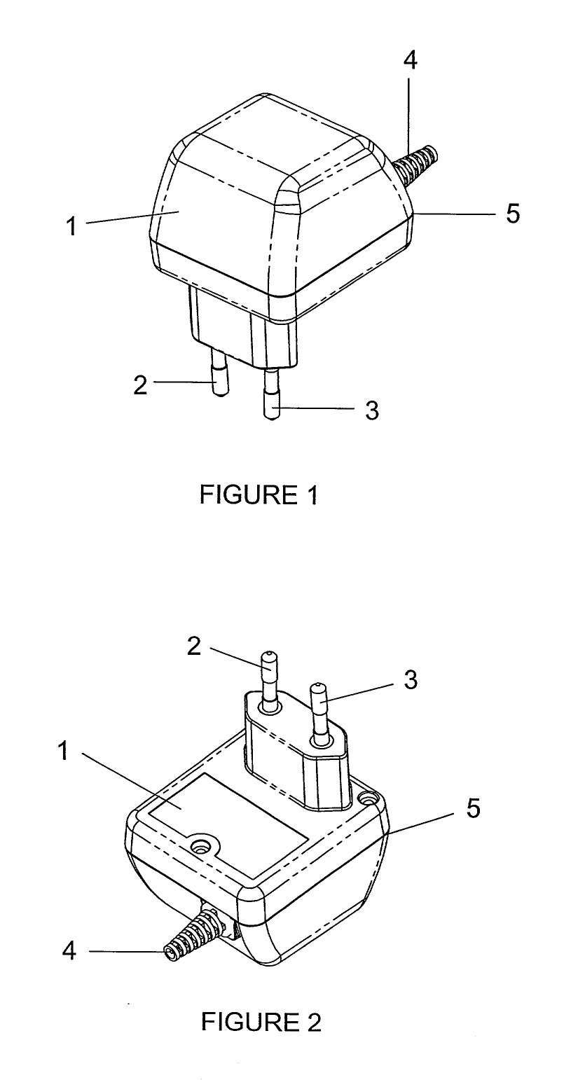

FIGS. 1 and 2 are perspective views of a battery charger that, externally, is substantially identical to those of known type. An enclosure 1 houses a transformer and rectifier. Electrical pins 2 and 3 project from one side of the enclosure 1 and are in electrical connection with the transformer. The pins 2 and 3 are adapted to plug into an electrical wall outlet (not shown) to energise the transformer. An electrical output cord (not shown) emerges from an aperture (shown with cord protector 4) in the enclosure 1.

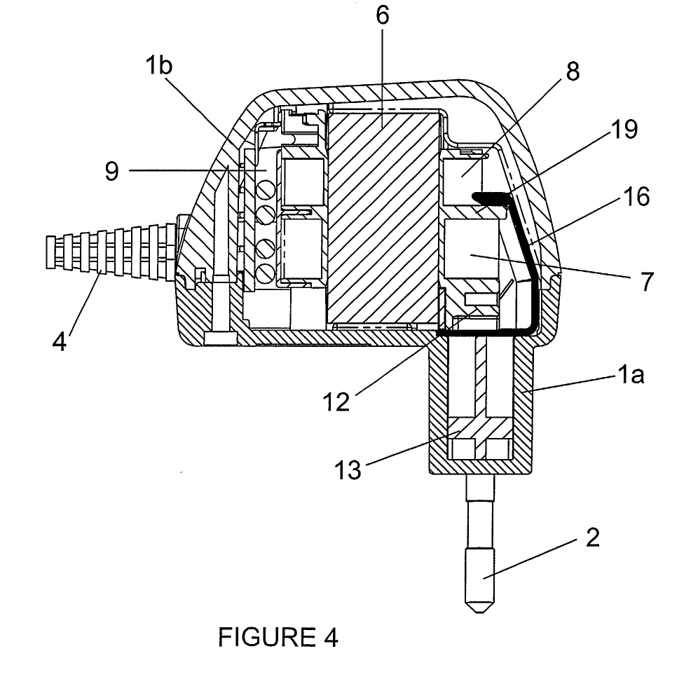

Referring to FIGS. 3 and 4, the enclosure 1 is separable at an equator 5 into two enclosure halves 1a and 1b. Within the enclosure 1 is a transformer comprising an iron core 6 carrying a winding bobbin 19 with a first, or primary, winding 7 and second, or secondary, winding 8 wound thereon. The secondary winding 8 is in electrical connection with a rectifier 9 for providing a low voltage DC output from the battery charger.

The tails (not shown) of the primary winding 7 are connected to electrical connectors 10 and 11 respectively. The electrical connectors 10 and 11 are supported in a housing 12 at one end of bobbin 19.

A cartridge 13 bears the two electrical pins 2 and 3. The cartridge 13 is disposed in juxtaposition one enclosure half 1b so that pins 2 and 3 extend through apertures 14 and 15 therein. The pins 2 and 3 in FIGS. 1 to 4 are of a “European” type configuration.

When the two enclosure halves 1a and 1b are brought together to enclose the transformer the lower end of the electrical pins 2 and 3 engage the electrical connectors 10 and 11 to electrically communicate with the primary transformer winding 7. In this way, when the electrical pins are pluged into an electrical wall outlet the transformer is energised.

One uniqueness of the current invention is the provision of a second enclosure or cover 16 that encloses the electrical connectors 10 and 11 and at least the tail portions of transformer primary winding 7. The cover 16 has two apertures 17 and 18 therein to facilitate access to electrical connectors 10 and 11 by lower ends of pins 2 and 3. Apertures 17 and 18 have shrouds so that the connection between lower ends of pins 2 and 3 and connectors 10 and 11 are enclosed by the cover 16.

The cover 16 is made from fire retardant material and encloses the primary windings (“high voltage”) connection parts of the transformer in a fire retardant housing as require by the appropriate safety standards. The advantage of the invention is that it allows the outer enclosure 1 to be made to a lower fire retardant standard. The cover 16 provides the necessary protection. This reduces costs as a lower quantity of fire retardant material is required for the cover 16 while still providing a satisfactory level of safety for the transformer.

The choice of material depends on the operating temperature and normal fault operating temperature of the transformer. By way of example only, if the maximum abnormal/fault temperature required is 160° C. then a suitable plastic is Polybutylene Terephthalate (PBT) which has the following properties:

Flammability at 0.8 mm thick is 94V-0,

Thermal Properties: Heat deflection temperature at 0.45 Mpa is 220° C., Melting Point is 225° C., and Rated Temp at 0.75 mm thick is 140° C.

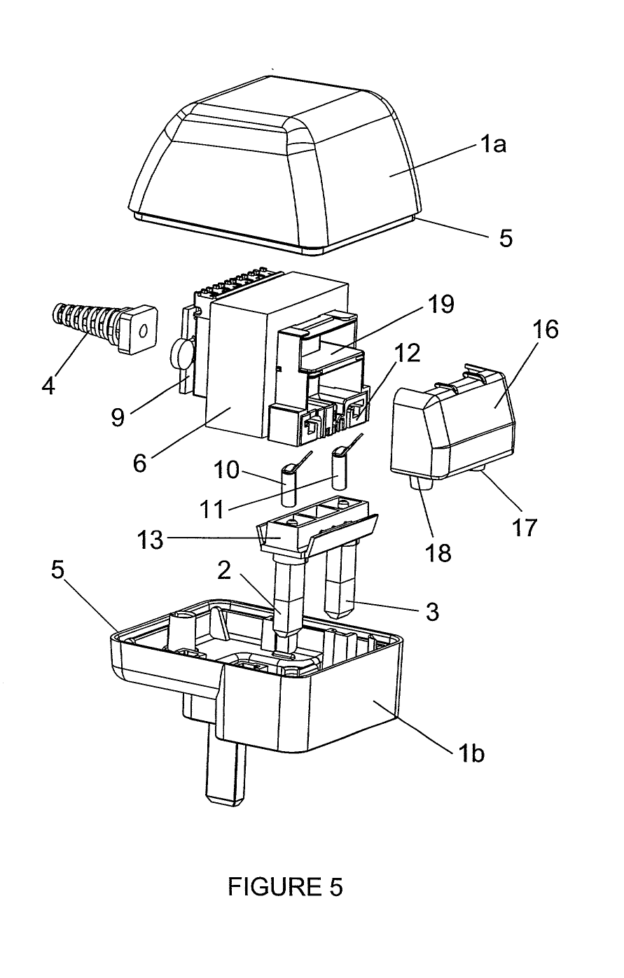

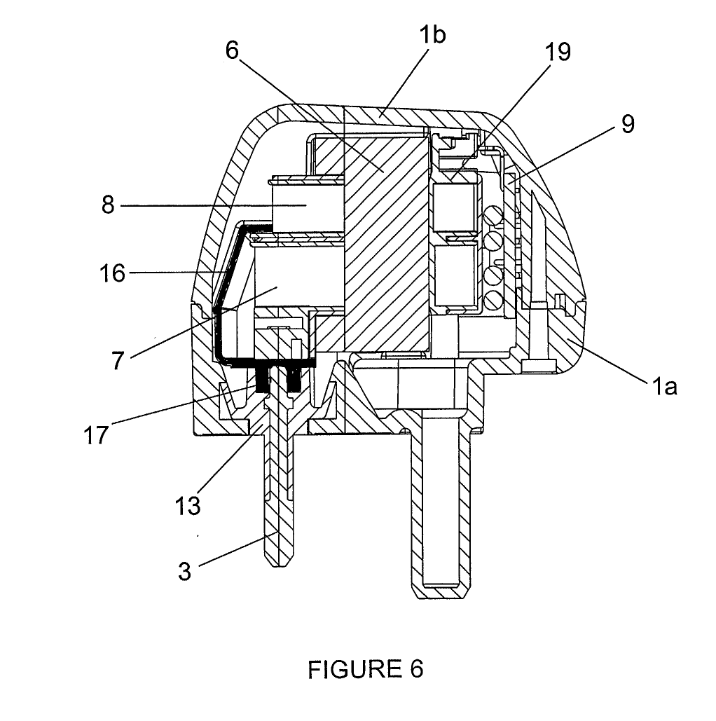

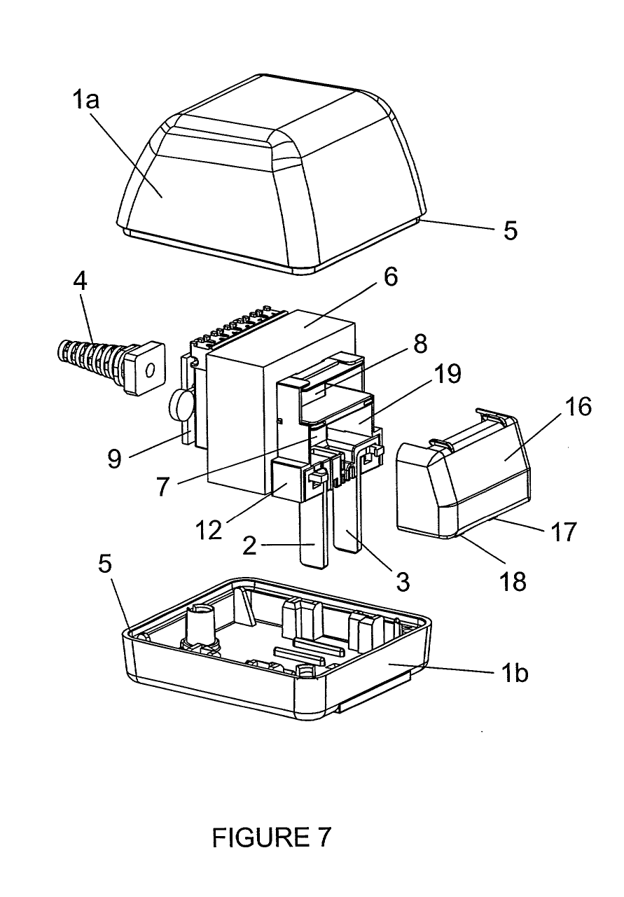

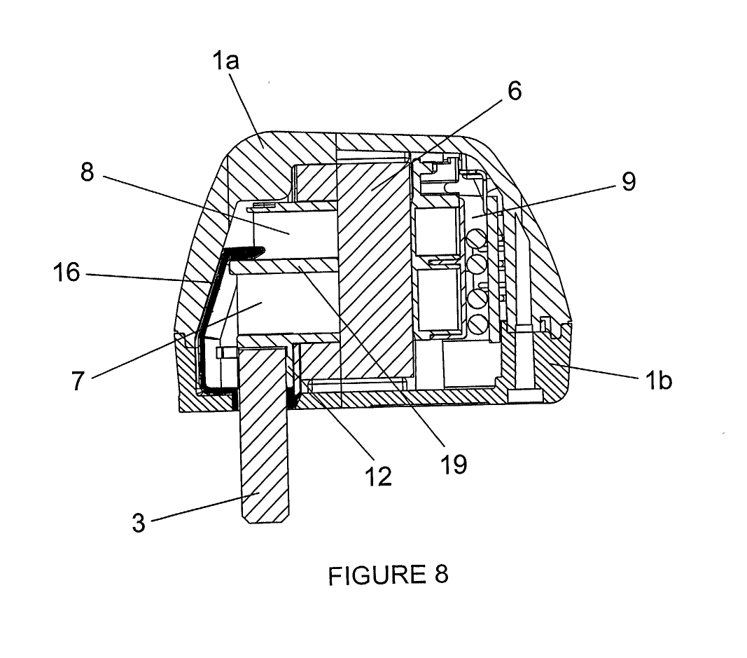

FIGS. 5 and 6 show a substantially identical arrangement using United Kingdom standard electrical pins 2 and 3. FIGS. 7 and 8 show yet a further substantially identical arrangement using United States standard electrical pins 2 and 3.

In an alternative embodiment of the invention connectors 10 and 11 are omitted and the electrical pins 2 and 3 are in direct electrical communication with the tails of the primary winding 7. This is the arrangement of the embodiment shown in FIGS. 7 and 8. The shrouds of apertures 17 and 18 in cover 16 enclose the electrical connection between pins 2 and 3 of primary winding 7.

Where in the foregoing description reference has been made to integers or elements have known equivalents then such are included as if individually set forth herein.

Embodiments of the invention have been described, however it is understood that variations, improvement or modifications can take place without departure from the sprite of the invention or scope of the appended claims.

What we claim is:

1. A transformer including:
first and second transformer windings,
an iron core carrying said first and second transformer windings,
an enclosure housing the iron core and first and second transformer windings,
first and second electrical connectors in electrical communication with the first transformer winding, and
a second enclosure encasing the electrical connectors and portion of the first transformer winding in electrical communication with the connectors.

2. A transformer as claimed in claim 1 wherein the second enclosure is made of a fire retardant material.

3. A transformer as claimed in claim 1 further including a electrical pin assembly, with first and second pins, in removable communication with the first and second electrical connectors, said pin assembly disposed to project from the outer surface of the enclosure to facilitate connection of the transformer to an electrical wall outlet.

4. A transformer as claimed in claim 1 further including a winding bobbin that forms part of the second enclosure.

5. A battery charger including:
first and second transformer windings,
an iron core carrying said first and second transformer windings,
an enclosure housing the iron core and first and second transformer windings,
an electrical pin assembly with first and second pins in electrical connection with the first transformer winding, and
a second enclosure made of fire retardant material encasing a portion of the electrical pin assembly and the first transformer winding in connection with the electrical pin assembly.

6. A battery charger as claimed in claim 5 wherein the first winding is formed on a bobbin that forms part of the second enclosure.
